(19) United States
(12) Patent Application Publication
(10) Pub. No.: US 2010/0101990 A1
(43) Pub. Date: Apr. 29, 2010

(54) Apparatus and Method for Isolation from and Support of a Carbon Filtration System from an Ion Exchange System

(75) Inventors: Steven J. Haehn, Oakdale, MN (US); David T. Bardwell, Woodbury, MN (US)

Correspondence Address: IPHORGAN, LTD., 1130 LAKE COOK ROAD, SUITE 240, BUFFALO GROVE, IL, 60089, US

(73) Assignee: ECOWATER SYSTEMS LLC, Woodbury, MN (US)

(21) Appl. No.: 11/740,260

(22) Filed: Apr. 25, 2007

Related U.S. Application Data
(60) Provisional application No. 60/886,849, filed on Jan. 26, 2007.
(60) Provisional application No. 60/745,559, filed on Apr. 25, 2006.

(51) Int. Cl. C02F 9/02

(52) U.S. Cl. 210/258

(57) ABSTRACT

A combination filtration and ion exchange system is provided. In one embodiment, the system includes a valve rotor, a carbon treatment tank, an ion exchange treatment tank and a valve. The valve rotor having a source water inlet, a service water outlet, a water treatment outlet, a water treatment inlet and a drain outlet. The carbon treatment tank having a service inlet and a service outlet, the service inlet coupled to the water treatment outlet. The ion exchange treatment tank having a service inlet and a service outlet, and the service outlet is coupled to the water treatment inlet. The valve having a carbon tank port, an ion exchange port, and a water treatment outlet, and a valve member having a first position and a second position, wherein in the first position, the service inlet of the ion exchange treatment tank is in fluid communication with the service outlet of the carbon treatment tank, and in the second position, the service inlet of the of the ion exchange treatment tank is in fluid communication with the water treatment outlet.

### TECHNICAL FIELD

The present invention relates to water treatment systems and particularly to water treatment systems having a carbon treatment stage and an ion exchange stage, wherein the carbon filtration system may be isolated from and supported by the ion exchange system.

### BACKGROUND OF THE INVENTION

It is known to provide a water treatment system in which carbon and ion exchange stages are connected in series, wherein water flows through one media followed by the other. The carbon tank provides removal of chlorine and the ion resin tank removes hardness. When the ion exchange resin needs to be regenerated, brine is introduced into the system, including the carbon bed. The brine is then flushed from the system to drain.

Once the brine solution has been introduced into the carbon bed either before or after going through the ion exchange resin, a large volume of water is required to sufficiently flush the brine from the carbon. The result of not flushing the brine from the carbon is that the initial product water delivered from the system will be high in total dissolved solids (TDS) which is both undesirable to the user and does not meet the National Sanitation Foundation (NSF) certification requirements for the minimum level of chlorides released from the system upon the completion of regeneration. In addition, if an amount of water sufficient enough to flush the TDS out of the system is used, the ratio of drain water to product water is higher than desirable and further does not meet requirements for NSF certification.

U.S. Pat. No. 6,085,788 discloses an example of a prior art valve rotor of an ion exchange stage and is incorporated herein by reference. U.S. Patent Application Publication No. 2006/0037900 discloses an example of a prior art ion exchange tank and is incorporated herein by reference.

### SUMMARY OF THE INVENTION

Accordingly, in the present invention, a means is provided to isolate or to decouple the carbon tank from the rest of the system during the ion exchange regeneration cycle or specific parts of the regeneration cycle such that the carbon bed is bypassed and no water that contains brine, and is therefore high in TDS, enters the carbon tank. This eliminates the undesirable TDS spike and the need to flush the TDS spike out of the carbon.

In addition to addressing the problem stated above, the ion exchange regeneration backwash and the carbon backwash functions can be optimized independently. In another embodiment, the frequency and duration of backwashing the carbon bed can be as required and does not have to occur with each regeneration backwash.

One embodiment of the invention incorporates a motorized ball valve in the flow path from the carbon tank to the ion exchange tank that operates in conjunction with the main system valve.

Another embodiment of this invention is to use a spool valve in place of the ball valve for the same function as described above. Yet another embodiment utilizes a check valve.

### BRIEF DESCRIPTION OF DRAWINGS

FIG. 1 is a schematic view of a prior art system with a valve adapter depicted in accordance with the present invention.

FIGS. 2A, 2B, and 2C are schematics which depict a motorized ball valve embodiment.

FIG. 3 is a schematic of the system of FIG. 1 of the present invention in a carbon backwash configuration.

FIG. 4 is a schematic of the system of FIG. 1 of the present invention in an ion exchange backwash configuration.

FIG. 5 is an exploded view of an adapter with a ball valve in accordance with the present invention.

FIG. 6 is a cross sectional view of the embodiment of FIG. 5, with the ball valve in a service and carbon backwash configuration.

FIG. 7 is a cross sectional view of the embodiment of FIG. 5, with the ball valve in a regeneration configuration.

FIG. 8 is a perspective view of the ball valve embodiment of FIG. 5 coupled between the ion exchange tank and the main rotor valve, and a perspective view of the carbon tank.

FIG. 9 is a schematic of a water softener system having the diverter valve in accordance with the present invention.

FIG. 10 is a schematic of a further embodiment of water softener system having a check valve.

FIG. 11 is a schematic view of a housing which may be adapted for the various embodiments disclosed herein, in accordance with the present invention.

### DETAILED DESCRIPTION OF INVENTION

FIG. 1 is a schematic view of a system 10 with a valve adapter 12 depicted in accordance with the present invention. In particular, an ion exchange tank 14 is shown with an adapter 12 and valve rotor assembly 16. The valve 18 of the present invention is located in the adapter 12. The valve 18 may be a solenoid or motorized valve, under the same control as the valve rotor assembly 16. The embodiment of FIG. 1 is shown as providing a carbon filtration tank 20 followed by an ion exchange tank 14. However, the present invention may be adapted to a system having an ion exchange tank 14 followed by a carbon filtration tank 20.

FIG. 1 shows a schematic for a lower radial port 22, an upper radial port 24, a service outlet 26, a service inlet 28, a service inlet 30, and a service outlet 32. A drain line 34 is shown coupled to a drain 36. A brine valve 38 is shown coupled to the rotor assembly 16.

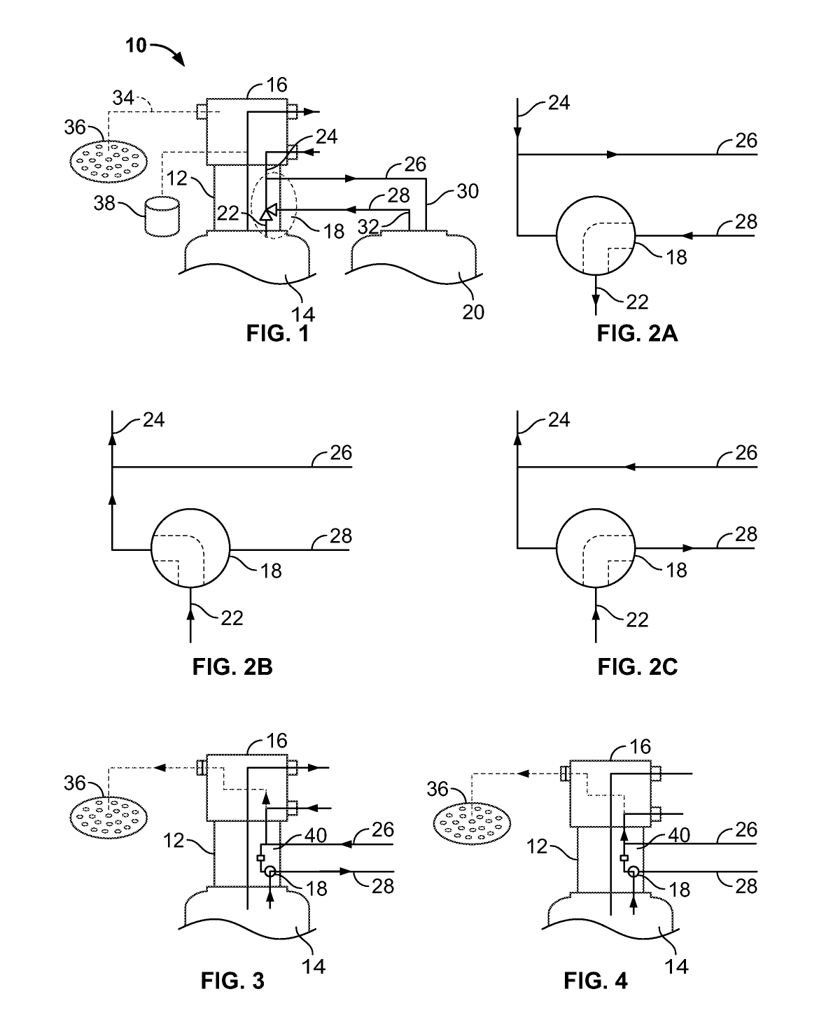

FIGS. 2A, 2B, and 2C are schematics which depict a motorized ball valve embodiment. FIG. 2A shows the motorized ball valve 18 in the position to provide either a service, fill or fast rinse operation. FIG. 2A shows an arrow pointing downward and which depicts the flow of water into the adapter 12 at which time it is diverted to the carbon tank 20 as depicted by the arrow pointing to the right. FIG. 2A also shows the valve 18 diverting the water from the carbon tank 20 to the resin bed (not shown) of the ion exchange tank 14. FIG. 2B shows the motorized ball valve 18 in the position to provide a brine, ion exchange backwash and a slow rinse. The valve 18 is diverting the water from the resin bed of the ion exchange tank 14 to the valve rotor assembly 16. The position of the valve 18 of FIG. 2B bypasses the carbon tank 20 from the flow of water. FIG. 2C shows the motorized ball valve 18 in the position to provide a carbon backwash. The valve 18 is shown diverting the water from the resin bed of the ion exchange tank 14 to the carbon tank 20. It will be appreciated that in this embodiment, when the carbon tank 20 is backwashed, the ion exchange tank 14 is also backwashed.

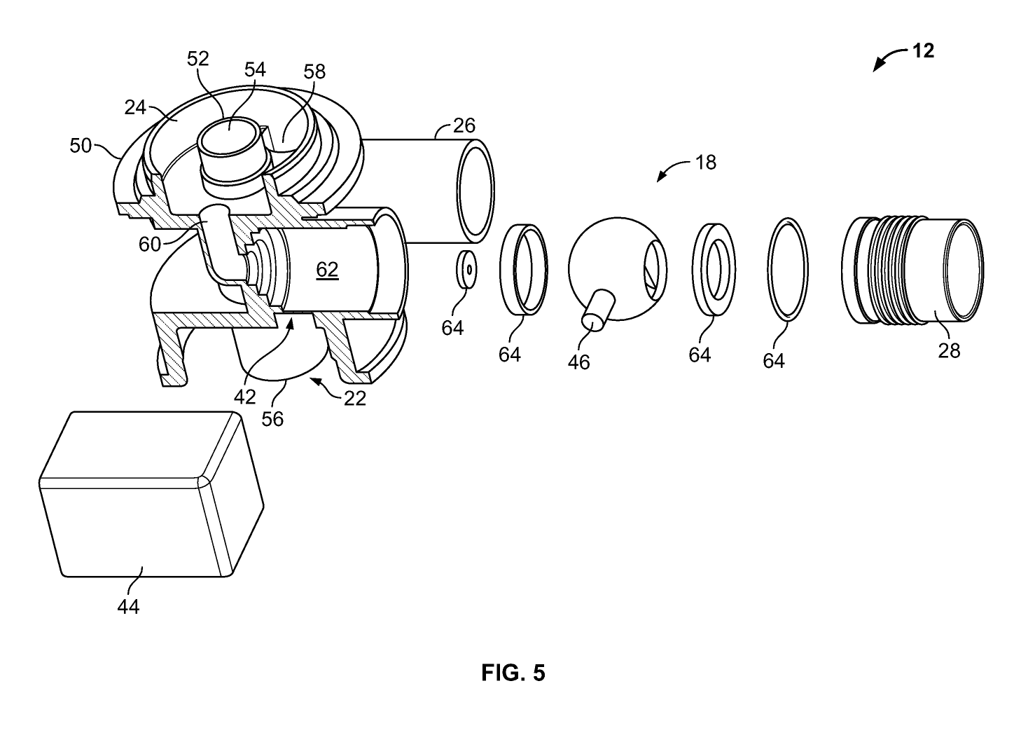

FIG. 3 is a schematic of the system of the present invention in a carbon backwash configuration, similar to that depicted in FIG. 2C. During the carbon backwash, the valve controller reverses the flow of water. The hard water enters the valve controller 16 and passes through the valve adapter 12 and then enters the riser pipe (not shown) of the ion exchange tank 14. After backwash of the resin bed (not shown), the water exits the ion exchange tank 14 and re-enters the valve adapter 12. The position of the valve 18 directs the flow to the carbon tank 20 for the carbon backwash step. The water exits the carbon tank 20 and is directed by the valve adapter 12 to the rotor valve 16, and then to a flow plug 40 prior to exiting the rotor valve 16 to the drain 36. The flow plug 40 is shown in this embodiment to be rated at 2.7 gallons per minute. It will be appreciated that the appropriate flow rate for the backwash is dependent on the particular system. FIG. 4 is a schematic of the system of the present invention in an ion exchange backwash configuration, similar to that depicted in FIG. 2B. As noted in connection with FIG. 2B, the position of the valve 18 bypasses the carbon tank 20. Thus, the carbon tank 20 is not backwashed when the ion exchange tank 14 is backwashed. As with the carbon backwash, the flow of water is reversed. The hard water enters the rotor valve 16 and is directed by the valve adapter 12 which in turn directs the flow to the riser pipe. After passing through the resin bed, the water is directed through a flow plug and the valve adapter 12. The flow plug is bypassed during the above-noted carbon backwash. The flow plug provides a lower rating of 1.7 gallons per minute as it is sized for the ion exchange backwash in this particular system. The flow of water is then directed through the previously noted 2.7 gallon per minute flow plug, then exits the valve controller 16 to the drain 36. It will be apparent that the 2.7 gallon per minute flow plug does not impact the ion exchange backwash, noting the upstream flow plug rated at 1.7 gallons per minute.

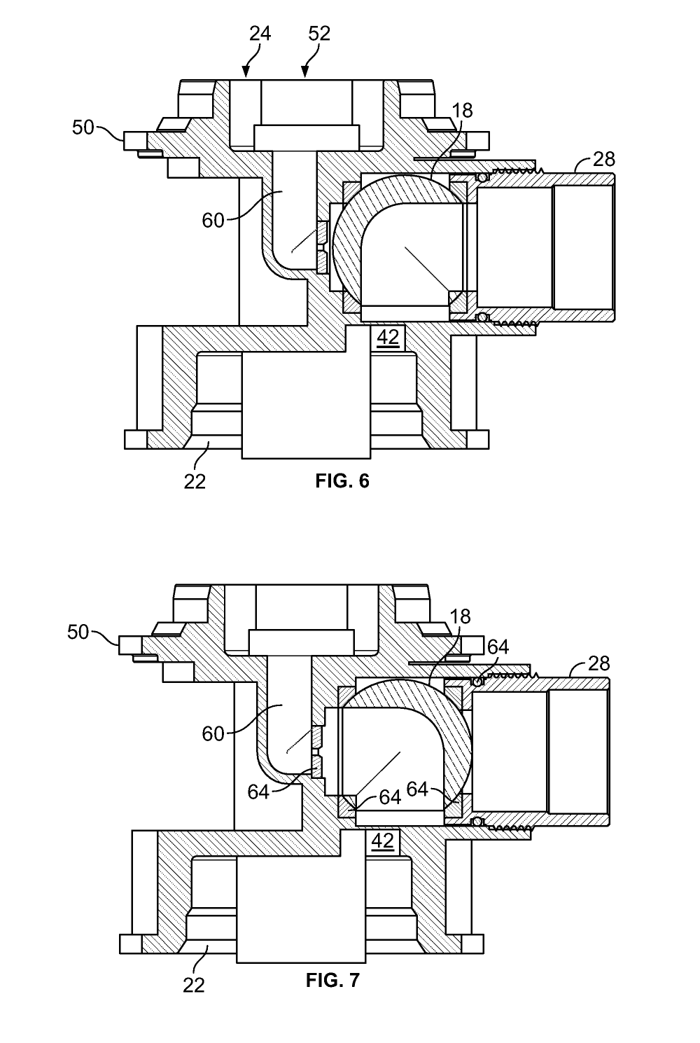

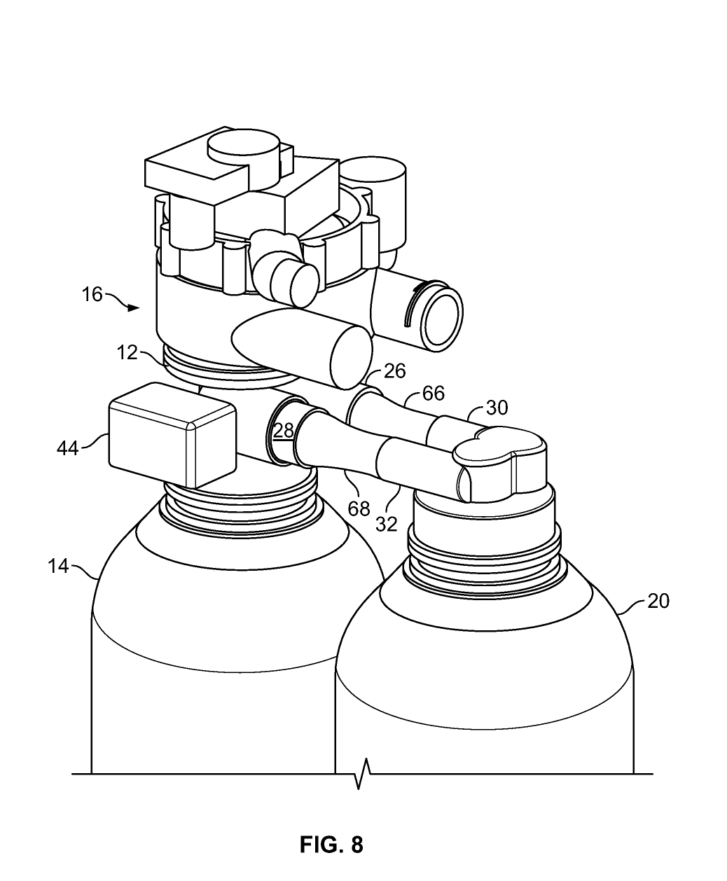

FIG. 5 is an exploded view of an adapter 12 with a ball valve embodiment. The adapter 12 is shown in partial perspective and partial cross sectional view. The ball valve assembly 18 is shown located at service inlet 28 of the adapter 12. A motor housing 44 is also shown. The housing 44 includes a motor (not shown) which is coupled to the stem 46 extending from the ball valve 18. The adapter 12 includes a housing 50 having a central bore 52 providing the upper central opening 54 and lower central opening 56. The lower central opening 56 is coupled to the riser (not shown) of the ion exchange tank 14. The housing 50 further shows an upper radial port 24 and a lower radial port 22. The upper radial port 24 is coupled via a fluid channel 58 to the service outlet 26 and to fluid channel 60. The fluid channel 60 is shown in FIG. 5 to be in fluid communication with a ball valve chamber 62, fluid channel 42 and the service inlet port 28. A plurality of seals 64 are also shown. FIG. 6 is a cross sectional view of the embodiment of FIG. 5, with the ball valve 18 in a carbon backwash, fill and fast rinse configuration. FIG. 7 is a cross sectional view of the embodiment of FIG. 5, with the ball valve 18 in a counter-current regeneration configuration. In particular, the valve position of FIG. 7 bypasses the carbon tank 20 during the brine draw, slow rinse and backwash steps of the counter-current regeneration. During each of these steps, the valve 18 directs the flow of water from the resin bed through the valve adapter 12, and to the rotor valve 16 which directs the flow to the drain. FIG. 8 is a perspective view of the ball valve adapter 12 of FIG. 5 coupled between the ion exchange tank 14 and the main rotor valve 16, and a perspective view of the carbon tank 20. In one position the ball valve 18 couples the service outlet 26 of the valve adapter 12 to the service inlet 30 of the carbon tank 20 via a first fluid conduit 66, and couples the service inlet 28 of the valve adapter 12 to the service outlet 32 of the carbon tank 20 via a second fluid conduit 68. In the other position of the ball valve 18, the carbon tank 20 is bypassed and the flow is directed between the resin bed of the ion exchange tank 14 and the main rotor valve 16. Rotation of the ball valve 18 may be accomplished with the system controller and ball valve motor (not shown) so that the ball valve function can be integrated with the functions of the entire system. It will also be appreciated that the first and second fluid conduits 66, 68 provide structural support for the carbon tank 20. In particular, in one embodiment, the ion exchange tank 14 may be installed upon a support surface or otherwise securely installed. A support structure, such as the first and second fluid conduits 66, 68, may provide the necessary support and stability for the carbon tank 20. For example, the carbon tank 20 may be formed in a more compact manner, such as an encapsulated filter cartridge as described below. The compact tank or cartridge may be supported and suspended by the support structure. In another embodiment, the support structure may include a housing (not shown) which is coupled between the ion exchange tank 14 and the carbon tank 20 or encapsulated cartridge. The housing may or may not include the fluid channels provided by the first and second fluid conduits 66, 68.

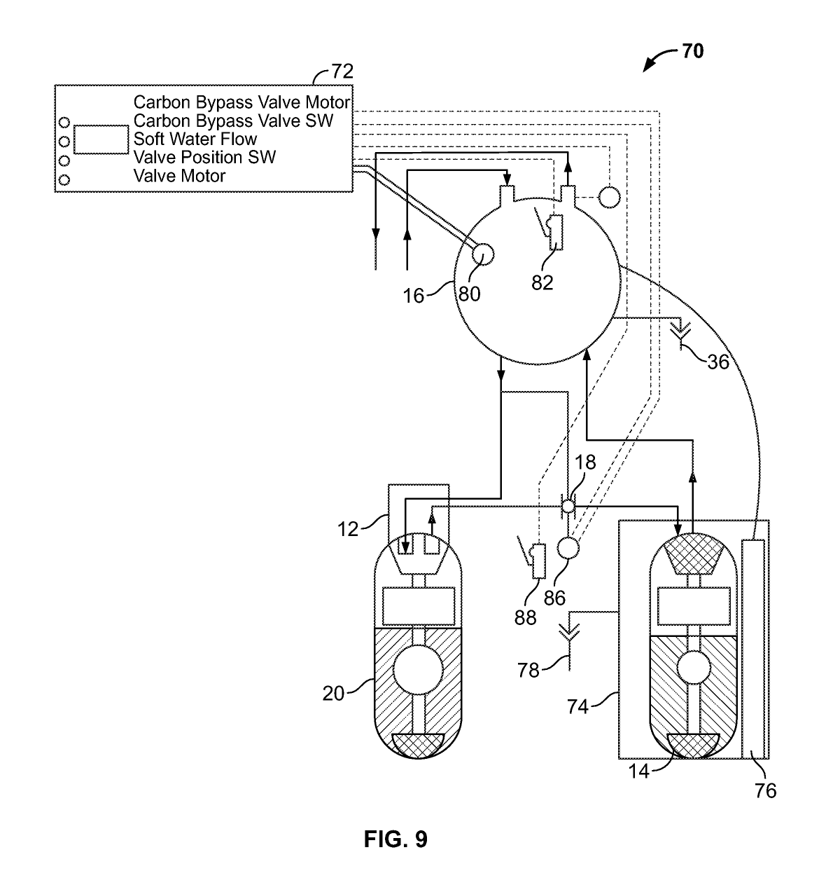

FIG. 9 is a schematic of a water softener system 70 having the diverter valve 18 in accordance with the present invention. A carbon treatment tank 20 is shown at the bottom left and an ion exchange resin tank 14 is shown at the bottom right of the figure. A controller and display board 72 is shown in the upper left of the figure. A valve rotor 16 is shown in the center of the figure. The valve rotor 16 is under control of the controller and directs the flow of water through the system. The diverter valve 18 is located below the valve rotor 16 and is also controlled by the controller. A brine tank 74, brine well 76, and drain 78, are shown. The rotor 16 is shown to include a motor 80, position switch 82, and drain 36. A motor 86 and a carbon bypass valve position switch 88 are shown coupled to the controller and display board 72.

During normal service, the source water enters the valve rotor 16 of FIG. 9 at the top left. The water exits the valve rotor 16 at the bottom left and enters the carbon tank 20. The carbon tank 20 removes chlorine from the source water. The outlet of the carbon tank 20 is coupled to the ion exchange resin tank 14 via the carbon bypass valve 18. The carbon bypass valve 18 may be located in an adapter such as shown in FIGS. 1, 3 and 4. The outlet of the ion exchange resin tank 14 is coupled to the valve rotor 16 which directs the water to the supply outlet.

During brine draw, slow rinse and backwash of regeneration, the controller provides signals to the valve rotor 16 and reverses the direction of the water flow. The controller also sends a signal to the carbon bypass valve 18 to change the position of the valve 18 and bypass the carbon tank 20. A salt solution or brine is directed to the service outlet of the ion exchange tank and through the resin bed. The brine then exits the ion exchange tank via the service inlet. The brine is then diverted by the carbon bypass valve away from the carbon tank and takes the vertical path as shown in FIG. 9 and flows to the valve rotor 16. The slow rinse and regeneration backwash direct flow down the riser pipe of the ion exchange tank 20 and then through the resin bed and out to the drain.

During the carbon tank backwash, service water is directed by the valve rotor 16 in a reverse direction to the ion exchange tank 14. However, in this embodiment, the carbon bypass valve 18 does not divert the flow away from the carbon tank 20. The controller provides a signal to the bypass valve 18 to couple the carbon tank 20. The flow continues from the ion exchange tank 14, through the carbon bypass valve 18, through the carbon tank 20, through the valve rotor 16 and out the drain line. It will be appreciated that the regeneration backwash can be optimized independent of the carbon backwash. For example, the frequency and duration of backwashing the ion exchange bed can be as required. In addition, generally the carbon backwash is required less frequently than the regeneration backwash. Thus, the frequency and duration of backwashing the carbon bed can be as required, regardless that the ion exchange tank 14 is being backwashed together with the carbon tank 20. In another embodiment, the ion exchange tank 14 is bypassed during the carbon backwash. In this manner, the effectiveness of the water used for the carbon backwash is not diminished by the backwash of the ion exchange bed prior to entering the carbon tank 20.

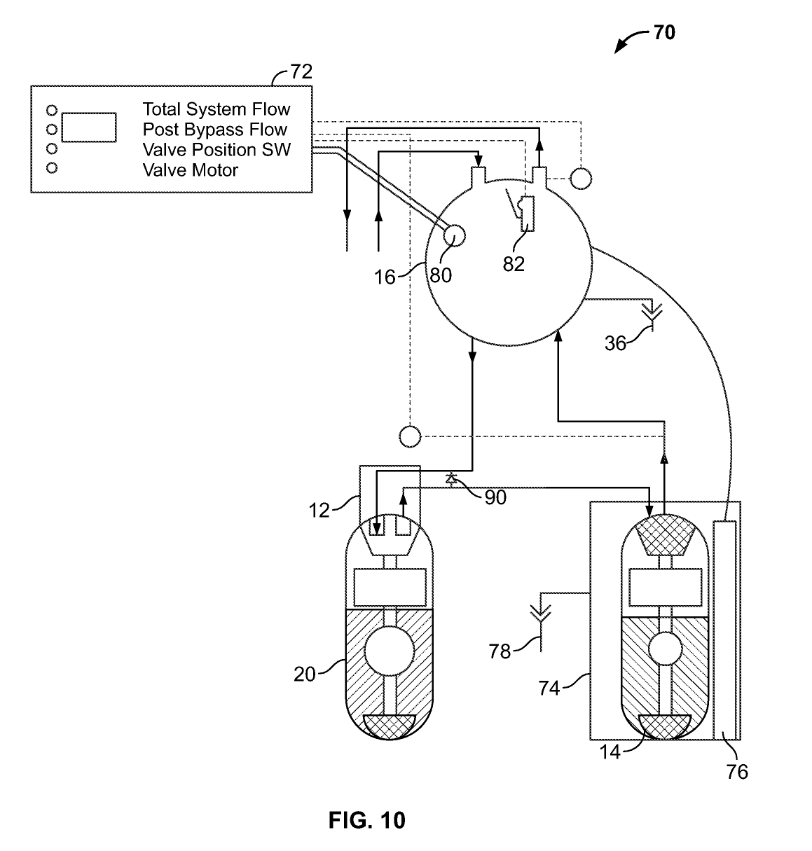

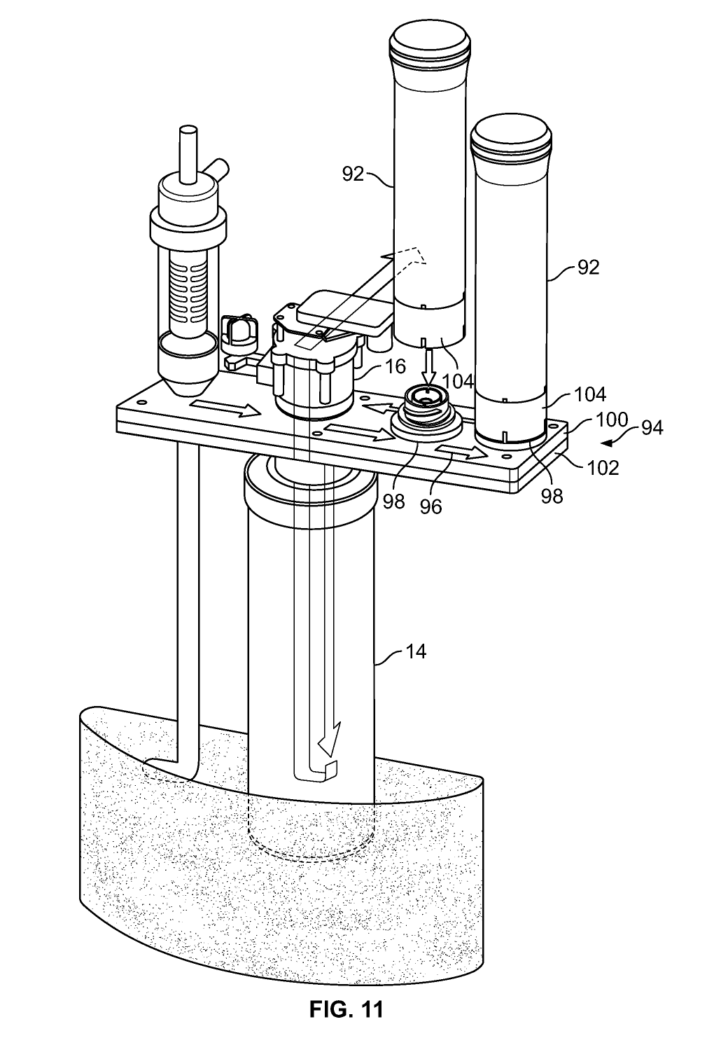

FIG. 10 is a schematic of a further embodiment of water softener system having a check valve 90 instead of a bypass valve 18. The check valve embodiment includes the benefit of not introducing an externally activated part, such as the ball valve 18. The system as shown in FIG. 10 operates similar to the system shown in FIG. 9. However, a check valve 90 is provided across the service inlet and outlet of the carbon tank 20. The check valve 90 blocks flow through the check valve 90 during service operation. However, during the brine draw, slow rinse and backwash cycles of the regeneration function, the check valve 90 essentially allows flow from the service inlet of the ion exchange tank 14 through the check valve 90, thus bypassing the carbon tank 90. During backwash of the carbon tank 90, service water is directed from the rotor valve 16 through the ion exchange tank 14 and the carbon tank 20. The check valve 90 may be adapted to provide a reduced flow rate in order to direct flow to the carbon tank 20 during backwash.

Tubing, conduit, or the like, may be provided to interconnect the adapter and the carbon tank, similar to the concept described in connection with FIG. 8. For example, in the embodiment of FIG. 8, respective tubing 66, 68 may be used to couple the two ports of the adapter 12 with the respective ports of the carbon tank 20. Alternatively, as noted above, a housing may be provided for interconnecting the ion exchange tank 14, the carbon tank 20 and the adapter 12. FIG. 11 shows another embodiment wherein an ion exchange tank 14 is coupled to an encapsulated carbon filter cartridge 92 via a housing 94. The housing 94 may incorporate the function of the adapter 12 as well as the additional fluid flow paths (which are represented by the arrows 96 shown in FIG. 11) which interconnect the ion exchange tank 14 and carbon tank 20 in a manner taught herein. In addition, the housing 94 includes fluid flow paths 96 for coupling to the main rotor valve 16. The housing 94 includes a connector (not shown, but may take the form of the lower portion of the adapter 12) for coupling to the ion exchange tank 14, a connector 98 for coupling to the cartridge 92, and a connector (not shown, but may take the form of the upper portion of the adapter 12) for coupling to the main rotor valve 16. The housing 94 may be configured for the diverter valve embodiment disclosed herein. Alternatively, the housing 94 may be configured for the check valve embodiment disclosed herein. In one embodiment, the housing 94 is configured as a manifold 94 having the respective fluid flow paths 96 and connectors. The manifold 94 may be in the form of two manifold halves 100, 102, wherein the inner face of one or both manifold halves 100, 102 provide for fluid flow paths 96. The manifold halves 100, 102 may be secured together in a manner known in the art, such as by hot plate welding.

The embodiment of FIG. 11 shows the manifold 94 having male bayonet connectors 98 and the encapsulated carbon filter cartridges 92 having female bayonet connectors 104. However, the manifold 94 may provide the female bayonet connectors for coupling to male bayonet connectors. Other connection fittings as understood in the art are also contemplated.

The encapsulated carbon filter cartridges 92 are shown connected to the upper half 100 of the manifold 94. It is also contemplated that the cartridges 92 be connected to and suspended from the lower half 102 of the manifold 94.

It will be appreciated that during the brine draw, the valve of the carbon bypass valve 18 may couple the carbon tank 20 to include the carbon tank 20 in the brine draw step.

1. A combination carbon filtration and ion exchange system, the system comprising:
a valve rotor having a source water inlet, a service water outlet, a water treatment outlet, a water treatment inlet and a drain outlet;
a carbon treatment tank having a service inlet and a service outlet;
an ion exchange treatment tank, the ion exchange tank having a service inlet and a service outlet; and
a valve having a carbon tank port, an ion exchange port, and a water treatment outlet, and a valve member having a first position and a second position.

2. The system of claim 1, wherein the valve includes an adapter located between the ion exchange treatment tank and the valve rotor, wherein the valve is located within the adapter.

3. A combination carbon filtration and ion exchange system, the system comprising:
a valve rotor having a source water inlet, a service water outlet, a water treatment outlet, a water treatment inlet and a drain outlet;
a carbon treatment tank having a service inlet and a service outlet;
an ion exchange treatment tank, the ion exchange tank having a service inlet and a service outlet; and
a check valve having an inlet port and an outlet port, wherein fluid flow is allowed in one direction, from the inlet to the outlet, the check valve is coupled across the inlet and outlet of the carbon treatment tank, with the inlet port coupled to the carbon service outlet, and the outlet port coupled to the carbon service inlet.

4. The system of claim 3, wherein the check valve is a pintle check valve.

5. A method of a combination carbon filtration and ion exchange system, the system comprising the steps of:
directing the water to be treated through a carbon treatment tank and an ion exchange treatment tank, during a service operation;
directing the brine solution through the ion exchange treatment tank during a brine draw operation; and
bypassing the carbon treatment tank during the brine draw operation.

6. The system of claim 5, further comprising the step of bypassing the carbon treatment tank during the ion exchange treatment tank backwash.

7. The method of claim 5, further comprising the step of bypassing the ion exchange treatment tank during the carbon treatment tank backwash.

8. The system of claim 5, further comprising the step of bypassing the carbon treatment tank during the regeneration slow rinse.

9. The system of claim 5, further comprising the step of backwashing the ion exchange tank and carbon treatment tank at the same time.

10. A water treatment system as described and claimed wherein the carbon tank is replaced by a tank having a water treatment media other than carbon.

11. The method as described and claimed herein wherein the regenerate is other than a brine regenerate.

12. A combination water filtration and ion exchange system, the system comprising:
a valve rotor having a source water inlet, a service water outlet, a water treatment outlet, and a water treatment inlet;
a first encapsulated filter cartridge having a fitting which provides an inlet and an outlet;
an ion exchange treatment tank, the ion exchange treatment tank having a service inlet and a service outlet; and
a manifold housing having a plurality of fluid channels extending within the housing, the housing further having a plurality of connection fittings, certain of the connection fittings are coupled to one or more of the fluid channels, wherein a first connection fitting is coupled to the ion exchange treatment tank, a second connection fitting is coupled to the first encapsulated filter cartridge and a third connection fitting is coupled to valve rotor, whereby the valve rotor controls fluid flow through the manifold, the first encapsulated filter cartridge and the ion exchange treatment tank.

13. The system of claim 12, wherein the manifold includes an upper half and a lower half, at least one of the halves includes grooves which form the plurality of fluid channels.

14. The system of claim 12, wherein the manifold housing provides structural support for the first encapsulated filter cartridge.

15. The system of claim 12, wherein the manifold housing includes an upper surface, the upper surface having a connection fitting which receives and supports the first encapsulated filter cartridge.

16. The system of claim 12, wherein the manifold housing includes a lower surface, the lower surface having a connection fitting which receives and suspends the first encapsulated filter cartridge.

17. The system of claim 12, further comprising a second encapsulated filter cartridge, and a second connection fitting which is coupled to the first encapsulated filter cartridge.

18. A combination water filtration and ion exchange system, the system comprising:
a valve rotor having a source water inlet, a service water outlet, a water treatment outlet, and a water treatment inlet;
a first filter unit having a fitting which provides an inlet and an outlet;
an ion exchange treatment tank, the ion exchange treatment tank having a service inlet and a service outlet; and
a support structure coupled between first filter and the ion exchange treatment tank, the support structure providing fluid communication between the first filter and the ion exchange treatment tank and structural support for the first filter unit.

19. The system of claim 18, wherein the first filter unit is an encapsulated filter cartridge and is suspended by the support structure.

20. The system of claim 1, wherein the service inlet of the carbon treatment tank is coupled to the water treatment outlet, the service outlet of the ion exchange treatment tank is coupled to the water treatment inlet, and wherein in the first position, the service inlet of the ion exchange treatment tank is in fluid communication with the service outlet of the carbon treatment tank, and in the second position, the service inlet of the of the ion exchange treatment tank is in fluid communication with the water treatment outlet.

21. The system of claim 3, wherein the service inlet of the carbon treatment tank is coupled to the water treatment outlet, and the service outlet of the ion exchange treatment tank is coupled to the water treatment inlet
